(19) United States
(12) Patent Application Publication
(10) Pub. No.: US 2024/0025411 A1
(43) Pub. Date: Jan. 25, 2024

(54) ON-BOARD DEVICE AND SERVER FOR CONTROLLING DRIVING OF VEHICLE WITHIN INTERSECTION

(71) Applicant: DENSO CORPORATION, Kariya-city (JP)

(72) Inventor: Toshio NOMURA, Kariya-city (JP)

(21) Appl. No.: 18/481,185

(22) Filed: Oct. 4, 2023

Related U.S. Application Data
(63) Continuation of application No. PCT/JP2022/010649, filed on Mar. 10, 2022.

(30) Foreign Application Priority Data
Apr. 6, 2021 (JP) 2021-064750

(51) Int. Cl. B60W 30/18; G01C 21/00

(52) U.S. Cl. CPC B60W 30/18159; G01C 21/3819; B60W 2552/53

(57) ABSTRACT

An on-board device for a vehicle, includes a map data storage unit configured to store map data including availability information that indicates availability of an auxiliary road marking within an intersection, an availability information acquisition unit configured to acquire the availability information; an availability determination unit configured to determine the availability of the auxiliary road marking within the intersection, indicated by the availability information and a driving assistance implementation unit configured to determine whether to implement driving assistance using the auxiliary road marking based on a result of determination of the availability of the auxiliary road marking within the intersection.

### CROSS-REFERENCE TO RELATED APPLICATION

This application is a continuation application of International Application No. PCT/JP2022/010649 filed Mar. 10, 2022 which designated the U.S. and claims priority to Japanese Patent Application No. 2021-064750 filed with the Japan Patent Office on Apr. 6, 2021, the contents of each of which are incorporated herein by reference.

### BACKGROUND

### Technical Field

The present disclosure relates to an on-board device and a server for controlling driving of a vehicle within an intersection.

### Related Art

Methods for generating a travel path for implementing driving assistance within an intersection have been provided. A first method is known to generate a travel path within an intersection based on an actual travel trajectory using the Global Positioning System (GPS). A second method is known to generate a travel path within an intersection based on auxiliary road markings, such as diamond-shaped markings painted on the road surface within the intersection.

### BRIEF DESCRIPTION OF THE DRAWINGS

In the accompanying drawings:

FIG. 1 is a functional block diagram illustrating the overall configuration of a vehicle communication unit according to one embodiment;

FIG. 2 is a functional block diagram illustrating a configuration of an on-board device;

FIG. 3 is an illustration of an example procedure of generating a first travel path (part 1);

FIG. 4 is an illustration of an example procedure of generating a first travel path (part 2);

FIG. 5 is an illustration of an example procedure of generating a first travel path (part 3);

FIG. 6 is an illustration of an example procedure of generating a first travel path (part 4);

FIG. 7 is an illustration of an example procedure of generating a first travel path (part 5);

FIG. 8 is an illustration of an example procedure of generating a second travel path;

FIG. 9 is an illustration of an example of auxiliary road marking availability data for an on-board device (part 1);

FIG. 10 is an illustration of an example of auxiliary road marking availability data for an on-board device (part 2);

FIG. 11 is a functional block diagram illustrating a configuration of a sever;

FIG. 12 is an illustration of an example of auxiliary road marking availability data for a server (part 1);

FIG. 13 is a flowchart of an auxiliary road marking availability data generation process (part 1);

FIG. 14 is a flowchart of an auxiliary road marking availability data generation process (part 2);

FIG. 15 is a flowchart of an auxiliary road marking availability data generation process (part 3);

FIG. 16 is an illustration of an example of auxiliary road marking availability data for an on-board device (part 3);

FIG. 17 is an illustration of an example procedure of storing various items of information in auxiliary road marking availability data for an on-board device (part 1);

FIG. 18 is an illustration of an example procedure of storing various items of information in auxiliary road marking availability data for an on-board device (part 2);

FIG. 19 is a flowchart of an auxiliary road marking availability data transmission process;

FIG. 20 is a flowchart of a map data update process;

FIG. 21 is a flowchart of a map data delivery process; and

FIG. 22 is an illustration of an example of auxiliary road marking availability data for a server (part 2).

### DESCRIPTION OF SPECIFIC EMBODIMENTS

The first known method, as disclosed in JP 2019-114005 A, may not be able to properly generate travel paths within intersections at locations where the GPS positioning accuracy is low. The second known method, as disclosed in JP 2020-38365 A, includes generating, based on auxiliary road markings within an actually existing intersection, a travel path within the intersection. Although the second known method is not affected by the GPS positioning accuracy, the travel path within the intersection generated based on the auxiliary road markings may not be realistic. For example, since the body size of a standard-sized vehicle differs from that of a large-sized vehicle, the travel path suitable for the standard-sized vehicle to turn right in an intersection differs from that suitable for the large-sized vehicle to turn right in an intersection in countries or regions where the Road Traffic Laws stipulates left-hand traffic. The travel path suitable for turning right in an intersection when there are no oncoming vehicles differs from the travel path suitable for turning right in an intersection when there are oncoming vehicles. Thus, there are circumstances in which auxiliary road markings at intersections may not be utilized properly.

In view of the above, it is desired to have a technique for properly taking advantage of auxiliary road markings within intersections.

One aspect of the present disclosure provides an on-board device for a vehicle, including: a map data storage unit configured to store map data including availability information that indicates availability of an auxiliary road marking within an intersection; an availability information acquisition unit configured to acquire the availability information; an availability determination unit configured to determine the availability of the auxiliary road marking within the intersection, indicated by the availability information; and a driving assistance implementation unit configured to determine whether to implement driving assistance using the auxiliary road marking based on a result of determination of the availability of the auxiliary road marking within the intersection.

The on-board device configured as above acquires availability information indicating availability of the auxiliary road marking within the intersection, determines the availability of the auxiliary road marking within the intersection, and determines whether to implement driving assistance using the auxiliary road marking based on the determination of the availability of the auxiliary road marking within the intersection. When it is determined that the auxiliary road marking within the intersection is unavailable, driving assistance is not implemented using the auxiliary road marking. When it is determined that the auxiliary road marking within the intersection is available, driving assistance is implemented using the auxiliary road marking. This allows for implementation of driving assistance using an auxiliary road marking within an intersection only in a situation where it is appropriate to use the auxiliary marking within the intersection, and thus allows for proper use of the auxiliary road marking within the intersection.

One aspect of the present disclosure provides an on-board device for a vehicle, including: an auxiliary road marking availability data generation unit configured to generate auxiliary road marking availability data that includes availability information indicating availability of an auxiliary road marking within an intersection, and a transmission control unit configured to transmit the auxiliary road marking availability data to a server.

The on-board device configured as above generates auxiliary road marking availability data including availability information indicating availability of the auxiliary marking within the intersection and transmits the generated auxiliary road marking availability data to the server. This allows the server to manage the availability of the auxiliary road marking within the intersection, allowing for proper use of the auxiliary road marking within the intersection.

One aspect of the present disclosure provides a server communicable with an on-board device for a vehicle, including: a map data storage unit configured to store map data; a reception control unit configured to receive auxiliary road marking availability data from the on-board device, the auxiliary road marking availability data including availability information that includes availability of an auxiliary road marking within an intersection; and a map data update unit configured to update the map data by reflecting the availability information in the map data.

The server configured as above, upon receiving the auxiliary road marking availability data from the on-board device, update map data by reflecting the auxiliary road marking availability data in the map data. This allows for generation of map data that reflects availability of an auxiliary road marking within an intersection, thereby allowing for proper use of the auxiliary road marking within the intersection.

Hereinafter, one exemplary embodiment of the present disclosure will be described in detail with reference to the accompanying drawings. The present embodiment covers countries and regions where Road Traffic Laws stipulate left-hand traffic. Auxiliary road markings within an intersection are road markings that guide a vehicle in the direction of travel when the vehicle turns right within the intersection, and may include diamond-shaped markings, zebra zones, lane demarcation lines, and specific colored areas painted on the road surface within the intersection. For example, a lane demarcation line may be represented as an auxiliary line, while a diamond-shaped marking, a zebra zone, or a specific-colored area may be described as an auxiliary area. Auxiliary road markings within intersections are indications other than those specified in the Road Traffic Law or traffic regulations, and may be so-called non-statutory indications installed for the safety and smoothness of traffic. Driving assistance includes both concepts of assistance during autonomous driving, which does not require the driver's operations, and assistance during manual driving, which assists the driver's operations.

In the following, use of the plural in connection with the auxiliary road markings when describing the embodiment does not imply that there needs to be more than one auxiliary road marking.

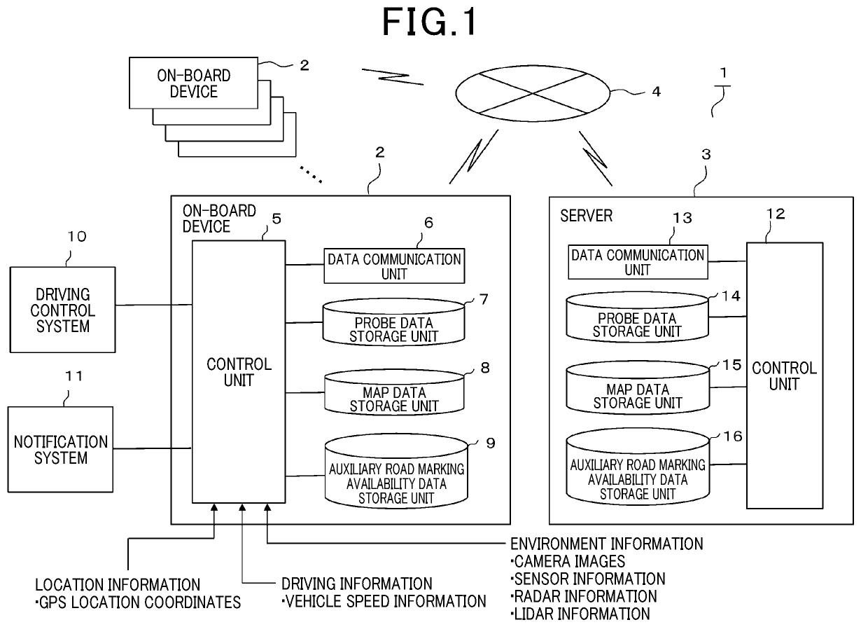

As illustrated in FIG. 1, in a vehicle communication system 1, an on-board device 2 mounted to each vehicle and a server 3 disposed on the network side can communicate data with each other via a communication network 4 that includes, for example, the Internet or the like. The vehicle carrying the on-board device 2 may be a vehicle having an autonomous driving function or a vehicle without an autonomous driving function. The vehicle having the autonomous driving function successively switches between autonomous driving and manual driving. The on-board devices 2 and the server 3 are in a multiple-to-one relationship, and the server 3 is capable of communicating data with a plurality of the on-board devices 2.

Each on-board device 2 acquires, from various sensors and various electronic control units (ECUs) mounted to the vehicle carrying the on-board device 2, environment information regarding surroundings of the vehicle, driving information regarding driving of the vehicle, and location information regarding the location of the vehicle. The on-board device 2 acquires, as the environment information, camera images in the direction of travel of the vehicle captured by an on-board camera, sensor information detected around the vehicle by a sensor such as a millimeter wave sensor, radar information detected around the vehicle by radar, LiDAR information detected around the vehicle by light detection and ranging (LiDAR), and other information. The camera images include traffic lights, traffic signs, billboards, and lane demarcation lines on roads, and road markings in intersections as described above. The on-board device 2 may acquire, as the environment information, at least the camera images or one of the sensor information, the radar information, and the LiDAR information.

The on-board device 2 acquires, as the driving information, vehicle speed information detected by a vehicle speed sensor. The on-board device 2 acquires, as the location information, GPS location coordinates acquired based on GPS signals transmitted from global positioning system (GPS) satellites. The GPS location coordinates are coordinates indicating the location of the vehicle. Various global navigation satellite systems (GNSSs), including the GPS, GLONASS, Galileo, BeiDou, IRNSS or the like, may be used as satellite positioning systems.

The on-board device 2 includes a control unit 5, a data communication unit 6, a probe data storage unit 7, a map data storage unit 8, and an auxiliary road marking availability data storage unit 9. The control unit 5 is configured as a microcomputer including a central processing unit (CPU), a read-only memory (ROM), a random access memory (RAM), and an input/output (I/O) interface. The microcomputer performs processes corresponding to computer programs stored in a non-transitory tangible storage medium by executing the computer programs, thereby controlling the overall operations of the on-board device 2. The microcomputer refers to the same meaning as a processor. In the on-board device 2, the non-transitory tangible storage medium may share hardware with other computer resources. The probe data storage unit 7, the map data storage unit 8, and the auxiliary road marking availability data storage unit 9 may each be mainly configured as a non-transitory tangible storage medium that is independently provided for the corresponding data.

The server 3 includes a control unit 12, a data communication unit 13, a probe data storage unit 14, a map data storage unit 15, and an auxiliary road marking availability data storage unit 16. The control unit 12 is configured as a microcomputer including a central processing unit (CPU), a read-only memory (ROM), a random access memory (RAM), and an input/output (I/O) interface. The microcomputer performs processes corresponding to computer programs stored in a non-transitory tangible storage medium by executing the computer programs, thereby controlling the overall operations of the server 3. In the server 3 as well, the non-transitory tangible storage medium may share hardware with other computer resources. The probe data storage unit 14, the map data storage unit 15, and the auxiliary road marking availability data storage unit 16 may each be mainly configured as a non-transitory tangible storage medium that is independently provided for the corresponding data.

In the on-board device 2, upon the control unit 5 acquiring the environment information, the driving control information, and the location information, the control unit 5 generates probe data from various information acquired, and stores the generated probe data in the probe data storage unit 7. The probe data is data configured to include the environment information, the driving information, and the location information. The probe data includes data indicating locations, colors, features, and relative positional relationships of traffic lights, traffic signs, billboards, lane demarcation lines on roads, and road markings within intersections. The probe data also includes data indicating a road shape, road features, a road width and the like of a road on which the vehicle is traveling.

The control unit 5 reads the probe data stored in the probe data storage unit 7 when a predefined amount of time has elapsed or when a traveled distance of the vehicle has reached a predefined distance, and transmits the read probe data from the data communication unit 6 to the server 3. In an alternative configuration where the server 3 transmits a probe data transmission request to the on-board device 2 every predefined cycle, the control unit 5 may, upon the data communication unit 6 receiving the probe data transmission request transmitted from the server 3, read the probe data stored in the probe data storage unit 7 and transmit the read probe data from the data communication unit 6 to the server 3. The control unit 5 may, for example, transmit from the data communication unit 6 to the server 3 the probe data accumulated in the trip from the previous switching on to off of the ignition at the time of switching on of the ignition, or may transmit from the data communication unit 6 to the server 3 the probe data accumulated in the trip from the current switching on to off of the ignition at the time of switching off of the ignition. When transmitting the probe data from the data communication unit 6 to the server 3, the control unit 5 may transmit from the data communication unit 6 to the server 3 the probe data in units of segments, which are predefined area units for managing maps, or may transmit from the data communication unit 6 to the server 3 the probe data in units of predefined areas regardless of the units of segments.

The map data storage unit 8 stores high-precision map data to implement driving assistance. The map data stored in the map data storage unit 8 includes three-dimensional map information, terrestrial object information, and road attribute information. The three-dimensional map information includes point clouds of feature points of road shapes and structures. The terrestrial object information includes shape and location information regarding lane demarcation lines, stop lines, pedestrian crossings, and auxiliary road markings within intersections. The road attribute information is information regarding lanes of each road, including the number of lanes and whether there is a right-turn lane. The map data stored in the map data storage unit 8 is sequentially updated by downloading map data stored in the map data storage unit 15 of the server 3 described later from the server 3 to the on-board device 2.

In the server 3, the map data storage unit 15 stores high-precision map data to implement driving assistance. The map data stored in the map data storage unit 15 is larger in volume than the map data stored in the map data storage unit 8 of the on-board device 2, and the map data stored in the map data storage unit 15 reflects information over a wide area. The control unit 12 receives the probe data transmitted from the on-board device 2 and stores the received probe data in the probe data storage unit 14. The control unit 12 reads the probe data stored in the probe data storage unit 14 and updates the map data stored in the map data storage unit 15 to reflect the read probe data.

In the present embodiment, the on-board device 2 and server 3 have the following functions for the purpose of utilizing auxiliary road markings within intersections. In addition to the above-described function of generating and transmitting the probe data, the on-board device 2 has a function of determining whether to implement driving assistance using auxiliary road markings based on a result of determination about availability of auxiliary road markings within an intersection, and a function of generating and transmitting auxiliary road marking availability data including availability information indicating whether the auxiliary road markings within the intersection are available to server 3. In addition to the above-described function of updating the map data by reflecting the probe data in the map data, the server 3 has a function of updating the map data by reflecting the availability information in the map data. The functions of on-board device 2 and the server 3 will now be described.

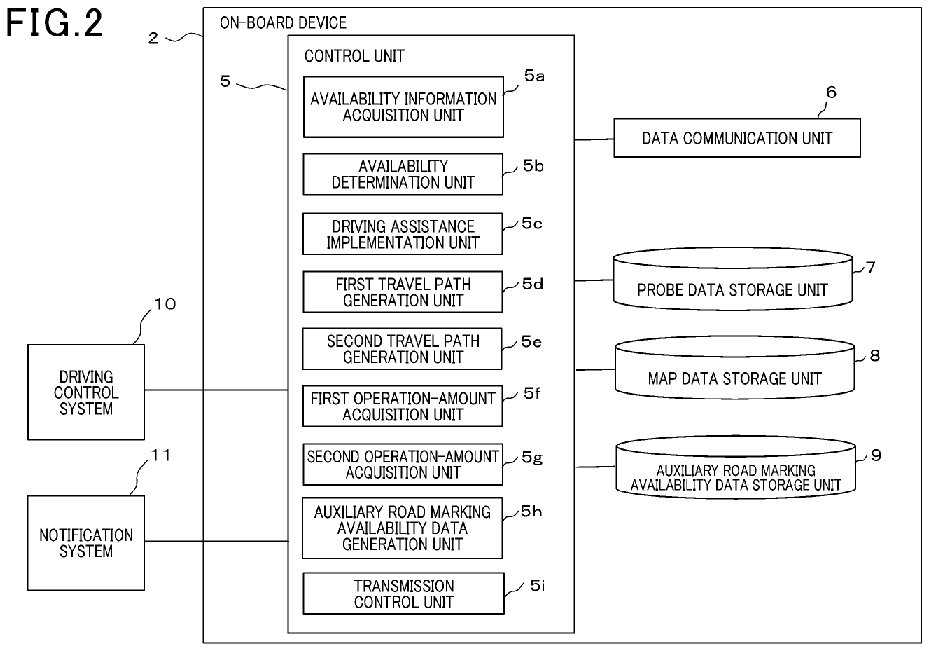

In the on-board unit 2, the control unit 5 includes the following functions as illustrated in FIG. 2: an availability information acquisition unit 5a, an availability determination unit 5b, a driving assistance implementation unit 5c, a first travel path generation unit 5d, a second travel path generation unit 5e, a first operation-amount acquisition unit 5f, a second operation-amount acquisition unit 5g, an auxiliary road marking availability data generation unit 5h, and a transmission control unit 5i. These blocks 5a to 5c correspond to functions implemented by a driving assistance implementation program, and the blocks 5d to 5i correspond to functions implemented by an auxiliary road marking availability data transmission program. That is, the control unit 5 implements the functions of the blocks 5a-5c by executing the driving assistance implementation program, and the functions of the blocks 5d-5i by executing the auxiliary road marking availability data transmitter program.

Upon the map data transmitted from the server 3 being received by the data communication unit 6 and stored in the map data storage unit 8, the availability information acquisition unit 5a reads the map data from the map data storage unit 8 and acquires the availability information reflected in the map data so read. Upon the availability information acquisition unit 5a acquiring the availability information, the availability determination unit 5b determines the acquired availability information.

Upon the availability information being determined by the availability determiner 5b, the driving assistance implementation unit 5c determines whether to implement driving assistance using auxiliary road markings based on the result of determination, and outputs control signals to the driving control system 10 and the notification system 11. If the result of determination of the availability information is “AVAILABLE”, the driving assistance implementation unit 5c outputs, to the driving control system 10 and the notification system 11, control signals that instruct implementation of driving assistance using auxiliary road markings. If the result of determination of the availability information is “UNAVAILABLE”, the driving assistance implementation unit 5c outputs, to the driving control unit 10 and the notification system 11, control signals that instruct implementation of driving assistance without using auxiliary road markings.

The driving control system 10 controls driving of the vehicle, including acceleration control, deceleration control, and steering control. During autonomous driving, upon acquiring a control signal from the driving assistance implementation unit 5c, the driving control system 10 controls driving of the vehicle such that the vehicle turns right within the intersection in accordance with the acquired control signal. That is, upon acquiring a control signal that instructs implementation of driving assistance using auxiliary road markings, the driving control system 10 controls driving of the vehicle such that the vehicle passes through the intersection according to the travel path using the auxiliary road markings. For example, in cases where an auxiliary road marking subjected to availability determination is a channelizing zone such as a diamond-shaped marking or a zebra zone, the driving control system 10 controls the vehicle to travel along a travel path set outside the channelizing zone without entering into the channelizing zone. For example, in cases where auxiliary road markings subjected to availability determination are a pair of lane demarcation lines on both sides of the lane, the travel control system 10 controls driving of the vehicle such that the vehicle travels along the travel path set in the area between the pair of lane demarcation lines.

Upon acquiring a control signal that instructs implementation of driving assistance without using auxiliary road markings, the driving control system 10 controls driving of the vehicle such that the vehicle passes through the intersection according to the travel path without using the auxiliary road markings. In cases where the auxiliary road marking subjected to availability determination is a channelizing zone, such as a diamond-shaped mark or a zebra zone, the driving control system 10 controls driving of the vehicle such that the vehicle travels along a travel path that is set independently of the channelizing zone. In cases where the auxiliary road markings subjected to availability determination are a pair of lane demarcation lines on both sides of the lane, the driving control system 10 controls driving of the vehicle such that the vehicle travels according to a travel path set independently of the pair of lane demarcation lines. Therefore, even in cases where the auxiliary road markings are intentionally set for the vehicle to avoid, a travel path may be set such that the vehicle steps on the auxiliary road markings.

The notification system 11 includes, for example, a meter indicator, a head-up display, and a speaker and the like, and notifies the driver of notification information. During manual driving, upon acquiring a control signal from the driving assistance implementation unit 5c, the notification system 11 notifies the driver of a driving operation such that the vehicle turns right within the intersection according to the acquired control signal. That is, upon acquiring a control signal that instructs implementation of driving assistance using auxiliary road markings, the notification system 6 notifies the driver of a stop position within the intersection, initiation and termination timings of steering, etc., according to the travel path using the auxiliary road markings. Upon acquiring a control signal that instructs implementation of driving assistance without using auxiliary road markings, the notification system 6 notifies the driver of a stop position within the intersection, initiation and termination timings of steering, etc. according to the travel path without using auxiliary road markings.

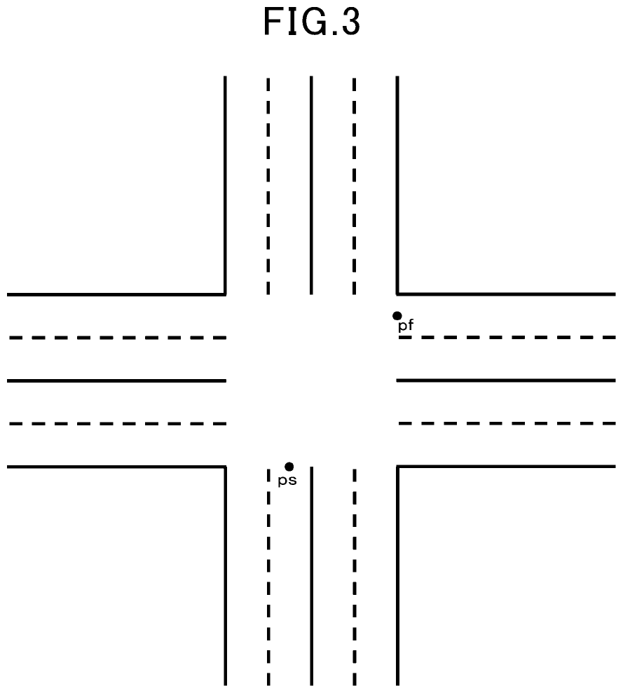

The first travel path generation unit 5d generates a travel path for implementing driving assistance without using auxiliary road markings within an intersection as a first travel path. Specifically, as described in FIG. 3, the first travel path generation unit 5d reads map data from the map data storage unit 8, and sets, for an intersection through which the vehicle will pass, a start point ps at an entrance to the intersection of the center line of an entrance lane which enters the intersection, and an end point pf at an exit from the intersection of the center line of an exit lane which exits the intersection. After setting the start point ps and the end point pf, the first acquisition unit 5d acquires, from the map data, location information and angle information for each of the start point ps and the end point pf. The location information for the start point ps is information indicating a location of the start point ps, and the angle information for the start point ps is information indicating a connection angle of the entrance lane at the start point ps to the intersection. The location information for the end point pf is information indicating a location of the end point pf, and the angle information for the end point pf is information indicating a connection angle of the exit lane to the intersection at the end point pf.

In addition to these items of information, the first travel path generation unit 5d may acquire information regarding distances from each of the start point ps and the end point pf to the left and right lane demarcation lines. The first acquisition path generation unit 5d may acquire at least some of information regarding the start point ps and the end point pf from camera images captured by the on-board camera or other detected information. That is, the first acquisition path generation unit 5d may acquire information regarding the start point ps based on information including the location and shape of the stop line on the entrance lane that is acquired by image recognition. The first acquisition path generation unit 5d may acquire information regarding the end point pf based on information including the location and shape of the stop line on the opposite lane from the exit lane, which is acquired by image recognition. The first acquisition path generation unit 5d may acquire these items of information by using the map data read from the map data storage unit 8 in combination with the camera images captured by the on-board camera.

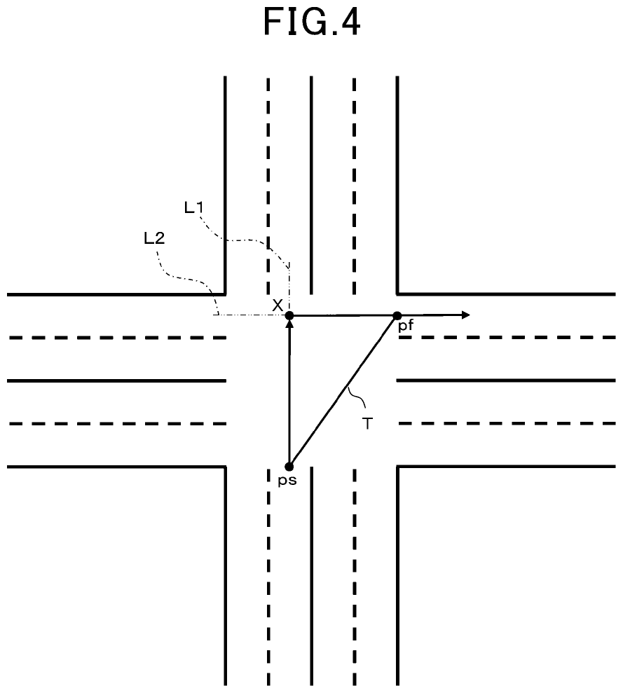

Next, the first travel path generation unit 5d sets an intersection point X as illustrated in FIG. 4, where a straight line L1 extending from the start point ps in the direction of entry into inside the intersection, i.e., forward in the direction of travel of the entrance lane, and a straight line L2 extending in the opposite direction from the direction of exit from inside the intersection to the end point pf, i.e., backward in the direction of travel of the exit lane intersect. After setting the intersection point X, the first travel path generation unit 5d sets a triangle T whose vertices are the three points: the start point ps, the end point pf, and the intersection point X.

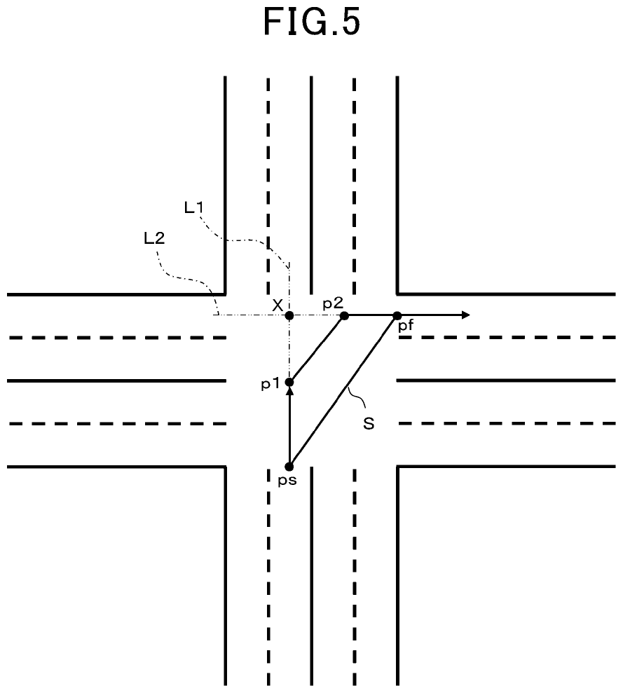

Next, as illustrated in FIG. 5, the first travel path generation unit 5d sets an additional point p1 on the line connecting the start point ps and the intersection point X, and sets an additional point p2 on the line connecting the end point pf and the intersection point X. In this case, the first travel path generation unit 5d calculates initial positions of the additional points p1 and p2 according to the following equations to set the additional points p1 and p2.

p1=α·ps+(1−α)·x

p2=β·pf+(1−β)·x

0<α<1

0<β<1

The initial values of α and β are, for example, 0.5. After setting the additional points p1 and p2, the first travel path generation unit 5d sets a quadrangle S with four vertices at the starting point ps, the end point pf, and the additional points p1 and p2.

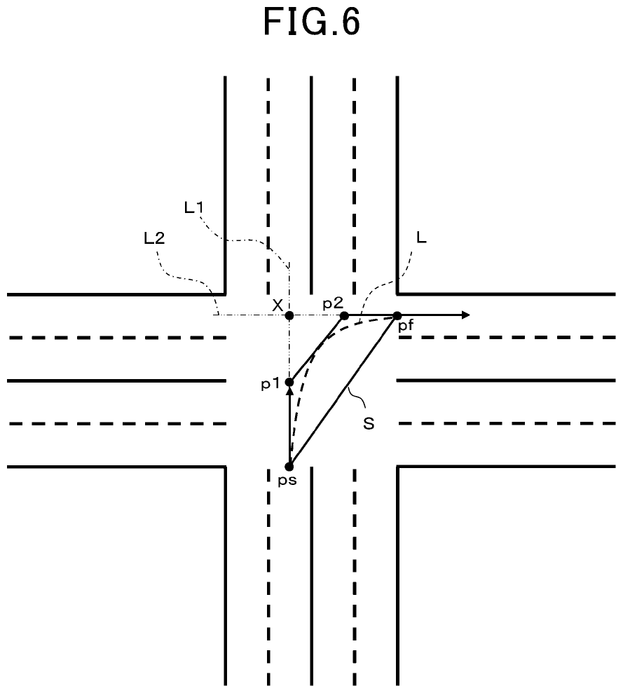

Next, as illustrated in FIG. 6, the first route generation unit 5d calculates a route line L (indicated by the dotted line) such that it fits within the quadrangle S described above. In this case, the first travel path generation unit 5d performs interpolation using a parametric curve of third order or higher with curvature continuity as an interpolation curve to stabilize the steering behavior when the vehicle is assumed to pass through the intersection along the route line L. For example, a Bézier curve, a B-spline curve or the like may be used as the parametric curve. When interpolation is performed using, for example, a third-order B-spline curve, the first travel path generation unit 5d treats the start point ps and the end point pf as triplicate control points to calculate a b-spline curve that reliably passes through the start point ps and the end point pf as the route line L.

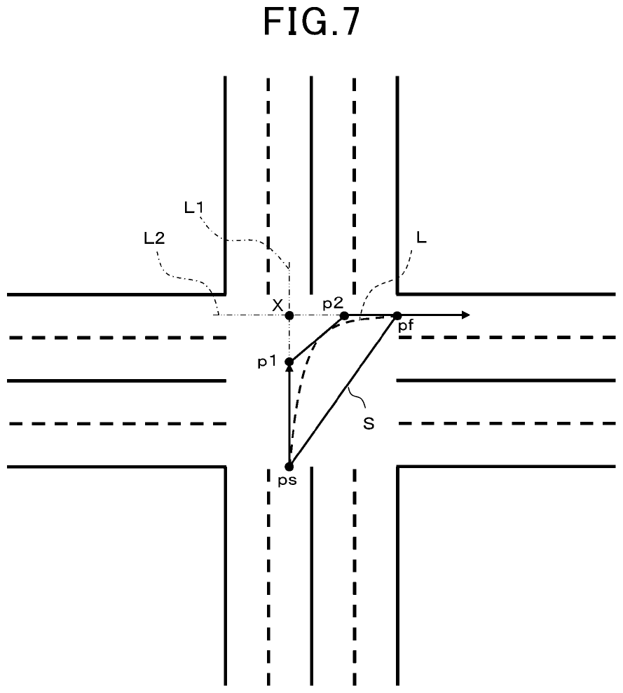

Next, the first travel path generation unit 5d evaluates the B -spline curve calculated in this way based on the curvature and the rate of change in curvature. The first travel path generation unit 5d evaluates the calculated B-spline curve by determining whether it meets a condition that the magnitude of the maximum curvature and the number of times the curvature changes from positive to negative and vice versa are both less than respective thresholds. When determining that the condition is met, the first travel path generation unit 5d uses the B-spline curve that meets the condition as the first travel path. On the other hand, when determining that the condition is not met, the first travel path generation unit 5d, as illustrated in FIG. 7, changes the positions of the additional points p1 and p2 by changing the values of α and β, calculates the B-spline curve again, and evaluates the B-spline curve again. The first travel path generation unit 5d repeats such calculation and evaluation of the B-spline curve, and uses the B-spline curve that meets the condition as the first travel path.

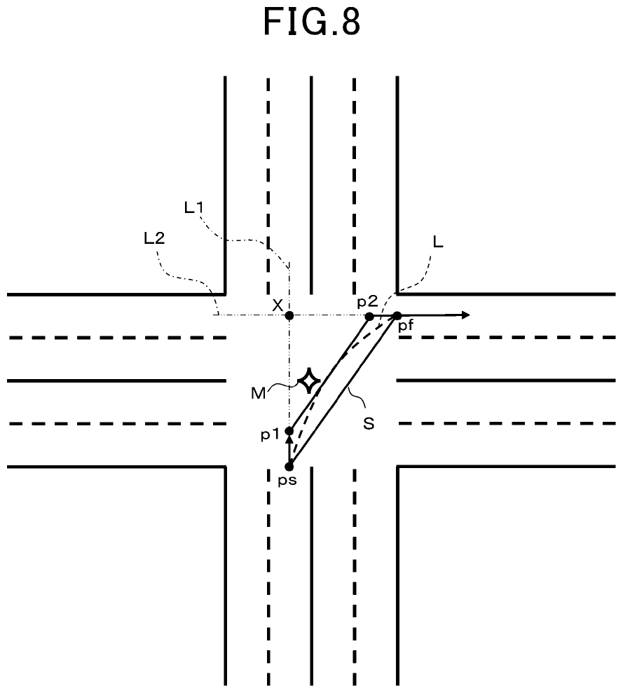

The second travel path generation unit 5e generates a second travel path for implementing driving assistance using auxiliary road markings within the intersection. Specifically, as illustrated in FIG. 8, when there is an auxiliary road marking within the intersection, for example, when a diamond-shaped mark M is painted on the road surface within the intersection, the second travel path generation unit 5e generates, as a second travel path, a travel path that can be traveled while approaching the auxiliary road marking and avoiding the auxiliary road marking as a non-travelable area. The second travel path generation unit 5e calculates a separation distance from the auxiliary road marking based on the position and size of the auxiliary road marking, the size of the vehicle body, and a predefined margin. The second travel path generation unit 5e re-calculates positions of the additional points p1 and p2 so as to meet a condition that a distance between the line segment connecting the additional points p1 and p2 and the auxiliary road marking is greater than or equal to the separation distance described above, and thereby sets again the additional points p1 and p2. The second route generation unit 5e sets a quadrangle S with four vertices at the start point ps, the end point pf, and the additional points p1 and p2 that were set again, calculates a B-spline curve as a route line L in the same manner as in the case of generating the first route line described above, and repeats calculation and evaluation of the B-spline curve, and uses the B-spline curve that meets the condition as the second travel path.

The first operation amount acquisition unit 5f uses the first travel path acquired by the first travel path generation unit 5d to acquire a first operation amount for the driving operation when the vehicle passes through the intersection according to the first travel path. The first operation amount is acquired as a measured value when the vehicle actually has passed through the intersection according to the first travel path.

The second operation amount acquisition unit 5g uses the second travel path acquired by the second travel path generation unit 5e to acquire a second operation amount for the driving operation when the vehicle passes through the intersection according to the second travel path. The second operation amount is acquired as a calculated value by simulation when the vehicle actually has passed through the intersection according to the first travel path.

The auxiliary road marking availability data generation unit 5h quantifies trajectories of the first and second travel paths, calculates a difference between the two, and thereby quantifies a divergence between the first and second travel paths. The auxiliary road marking availability data generation unit 5h determines the availability of the auxiliary road marking, i.e., whether the auxiliary road marking is available, by comparing the quantified divergence (hereinafter referred to as a degree of divergence) with a predefined value, and generates availability information indicating the availability of the auxiliary road marking. When determining that the degree of divergence is greater than or equal to the predefined value and and that the second travel path is extremely bulging outward, making an excessively wide turn or extremely constricted inward, making an excessively tight turn, relative to the first travel path, the auxiliary road marking availability data generation unit 5h determines that the auxiliary road marking is unavailable.

When determining that the degree of divergence is less than the predefined value and that the second travel path is neither extremely bulging outward, making an excessively wide turn nor extremely constricted inward, making an excessively tight turn, in comparison to the first travel path, the auxiliary road marking availability data generation unit 5h compares the first operation amount acquired by the first acquisition unit 5f and the second operation amount acquired by the second operation amount acquisition unit 5g. When determining that the second operation amount is not less than the first operation amount, i.e., the steering operation according to the second travel path is not smoother than the steering operation according to the first travel path, the auxiliary road marking availability data generation unit 5h determines that the auxiliary road marking is unavailable in this case as well. When determining that the second operation amount is less than the first operation amount, i.e., the steering operation according to the second travel path is smoother than the steering operation according to the first travel path, the auxiliary road marking availability data generation unit 5h determines that the auxiliary road marking is available.

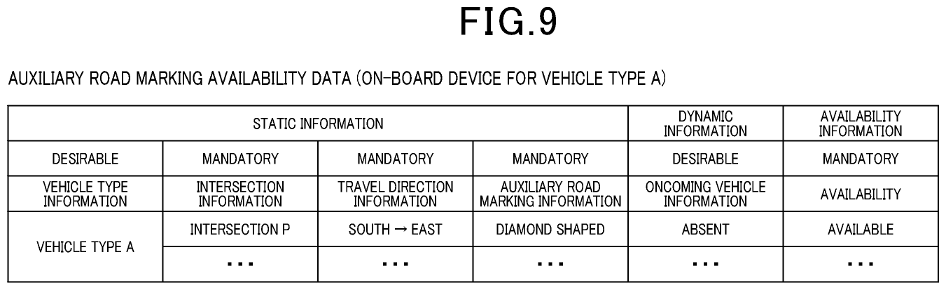

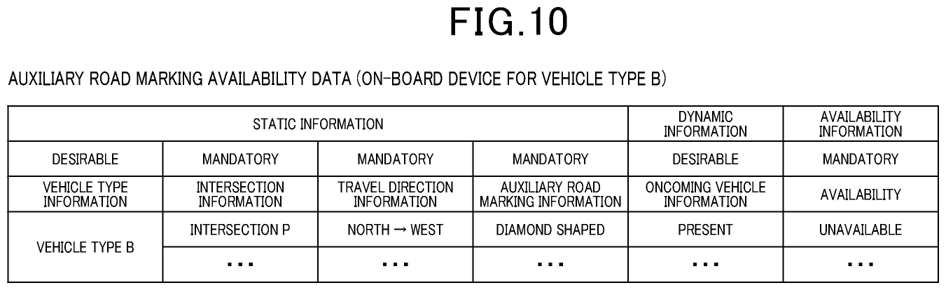

After determining the availability of the auxiliary road marking and generating the availability information, the auxiliary road marking availability data generation unit 5h generates auxiliary road marking availability data by associating the generated availability information with static information and dynamic information, as illustrated in FIG. 9 and FIG. 10. The static information includes vehicle type information indicating the vehicle type as a DESIRABLE item, intersection information indicating the intersection as a MANDATORY item, travel direction information indicating the travel direction of the vehicle, and auxiliary road marking information indicating the type of auxiliary road marking. The dynamic information includes oncoming vehicle information that indicates the presence or absence of an oncoming vehicle as a DESIRABLE item. The DESIRABLE item is not necessarily required, but the MANDATORY item is required.

The vehicle type information is included as an item in the auxiliary road marking availability data because a suitable travel path for the vehicle to make a right turn at an intersection is affected by the size of the vehicle. The oncoming vehicle information is included as an item in the auxiliary road marking availability data because a suitable travel path for the vehicle to make a right turn at an intersection may be affected by the presence or absence of an oncoming vehicle, i.e., whether the vehicle waits for an oncoming vehicle to pass before making a right turn or does not wait for an oncoming vehicle to pass, in the intersection. In addition, traffic light information may be added as the dynamic information, and it may be determined that no oncoming vehicles are present in a situation where the traffic light in the travel direction of the vehicle is lit red and a right turn arrow indicates that a right turn is allowed. The auxiliary road marking availability data generated by the auxiliary road marking availability data generation unit 5h has a data structure that includes, as constituents, the availability information indicating the availability of the auxiliary road marking in the intersection, the vehicle type information regarding the type of the vehicle carrying the on-board device 2, and the oncoming vehicle information regarding the presence or absence of an oncoming vehicle facing the vehicle carrying the on-board device 2.

FIG. 9 illustrates an example of auxiliary road marking availability data in a case where a vehicle of vehicle type A enters an intersection P with a diamond-shaped marking painted on the road surface from the south direction, makes a right turn in the intersection, and exits the intersection to the east, in a situation where there are no oncoming vehicles. In this case, the auxiliary road marking availability data generation unit 5h stores “INTERSECTION P” in the intersection information field, “SOUTH-->EAST” in the travel direction information field, “DIAMOND SHAPED” in the auxiliary road marking information field, and “ABSENT” in the oncoming vehicle information field. The auxiliary road marking availability data generation unit 5h compares the first operation amount acquired by the first operation amount acquisition unit 5f and the second operation amount acquired by the second operation amount acquisition unit 5g. When determining that the second operation amount is less than the first operation amount, the auxiliary road marking availability data generation unit 5h stores “AVAILABLE” in the availability information field.

FIG. 10 illustrates an example of auxiliary road marking availability data in a case where a vehicle of vehicle type B enters an intersection P from the north direction, makes a right turn in the intersection, and exits the intersection to the west, direction in a situation where there is an oncoming vehicle. In this case, the auxiliary road marking availability data generation unit 5h stores “INTERSECTION P” in the intersection information field, “NORTH-->WEST” in the travel direction information field, “DIAMOND SHAPED” in the auxiliary road marking information field, and “PRESENT” in the oncoming vehicle information field. The auxiliary road marking availability data generation unit 5h compares the first operation amount acquired by the first acquisition unit 5f and the second operation amount acquired by the second acquisition unit 5g. When determining that the second operation amount is not less than the first operation amount, the auxiliary road marking availability data generation unit 5h stores “UNAVAILABLE” in the availability information field.

The auxiliary road marking availability data generation unit 5h stores values in fields of the intersection information, the travel direction information, the auxiliary road marking information, the oncoming vehicle information, and the availability information as described above each time a vehicle passes through an intersection, and stores and accumulates auxiliary road marking availability data in the auxiliary road marking availability data storage unit 9.

When a transmission condition for auxiliary road marking availability data is met, the transmission control unit 5i reads the auxiliary road marking availability data stored in the auxiliary road marking availability data storage unit 9 and transmits the read auxiliary road marking availability data from the data communication unit 6 to the server 3. In this case, the transmission control unit 5i may synchronize transmission of the auxiliary road marking availability data to the server 3 with transmission of the probe data described above to the server 3, or may not synchronize transmission of the auxiliary road marking availability data to the server 3 with transmission of the probe data to the server 3. The transmission control unit 5i may transmit the auxiliary road marking availability data to the server 3, for example, upon elapse of a predefined amount of time or upon a traveled distance of the vehicle having reached a predefined distance. The transmission control unit 5i may transmit from the data communication unit 6 to the server 3 the auxiliary road marking availability data accumulated in the trip from the previous switching on to off of the ignition at the time of switching on of the ignition, or may transmit from the data communication unit 6 to the server 3 the auxiliary road marking availability data accumulated in the trip from the current switching on to off of the ignition at the time of switching off of the ignition.

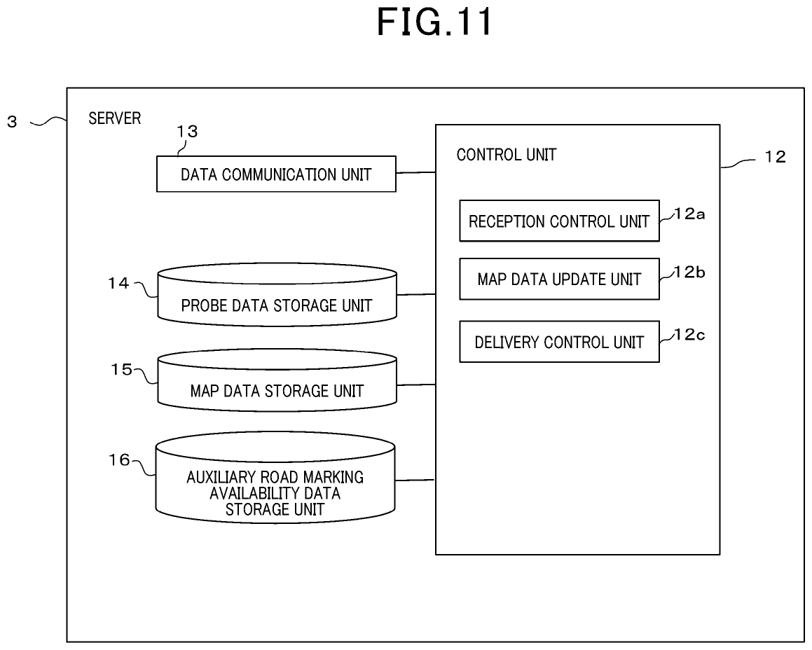

In the server 3, as illustrated in FIG. 11, the control unit 12 includes a reception control unit 12a, a map data update unit 12b, and a delivery control unit 12c. These blocks 12a to 12c correspond to functions implemented by a map data update program, and each of the blocks 12a to 12c corresponds to a function implemented by the map data update program. That is, the control unit 12 implements the functions of the blocks 12a-12c by executing the map data update program.

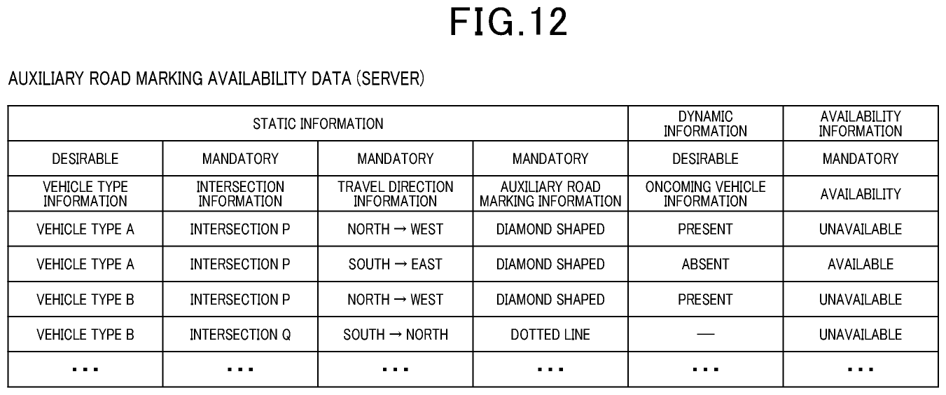

The reception control unit 12a receives the auxiliary road marking availability data transmitted from the on-board device 2 via the data communication unit 13 and stores the received auxiliary road marking availability data in the auxiliary road marking availability data storage unit 9. That is, since the reception control unit 12a receives auxiliary road marking availability data transmitted from an unspecified number of on-board devices 2, the reception control unit 12a manages the auxiliary road marking availability data by sorting it using, for example, vehicle type information, as illustrated in FIG. 12. In the auxiliary road marking availability data, vehicle types may be classified by vehicle, or by group as defined by the Road Traffic Law, such as standard motor vehicles, large motor vehicles, special large motor vehicles, motorcycles, and so on.

When a map data update condition is met, the map data update unit 12b reads the auxiliary road marking availability data stored in the auxiliary road marking availability data storage unit 16 and updates the map data stored in the map data storage unit 15 to reflect the read auxiliary road marking availability data. That is, the map data update unit 12b associates the intersection identified by the map data with the intersection identified by the auxiliary road marking availability data, and upon reading the map data, associates the map data with the auxiliary road marking availability data such that the auxiliary road marking availability data for the intersection included in the read map data is retrieved.

When a delivery condition for map data is met, the delivery control unit 12c reads the map data stored in the map data storage unit 15 and delivers the read map data from the data communication unit 13 to the on-board device 2. That is, given the map data read from the map data storage unit 15 reflecting the auxiliary road marking availability data, the delivery control unit 12c delivers the map data reflecting the auxiliary road marking availability data from the data communication unit 13 to the on-board device 2. In this case, for example, upon receipt of a map data transmission request transmitted from the on-board device 2, the delivery control unit 12c may deliver from the data communication unit 13 to the vehicle carrying the on-board device 2 that transmitted the map data transmission request, the map data around the location of the same vehicle. For example, in a configuration where the on-board device 2 transmits the map data request upon switching on of the ignition, the delivery control unit 12c may, upon switching on of the ignition, deliver the map data around the location of the vehicle carrying the on-board device 2 that transmitted the map data transmission request, from the data communication unit 13 to the same on-board device 2.

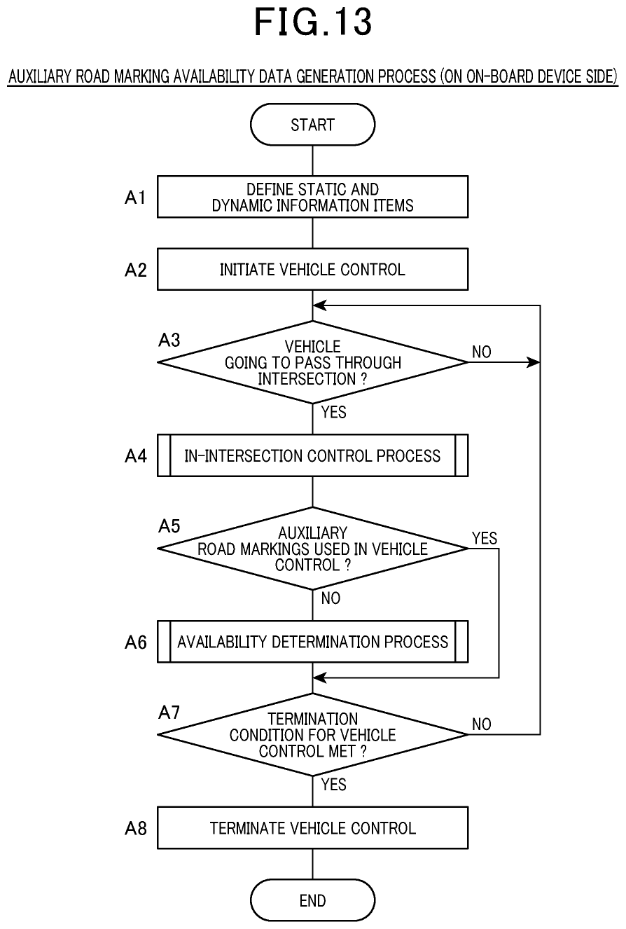

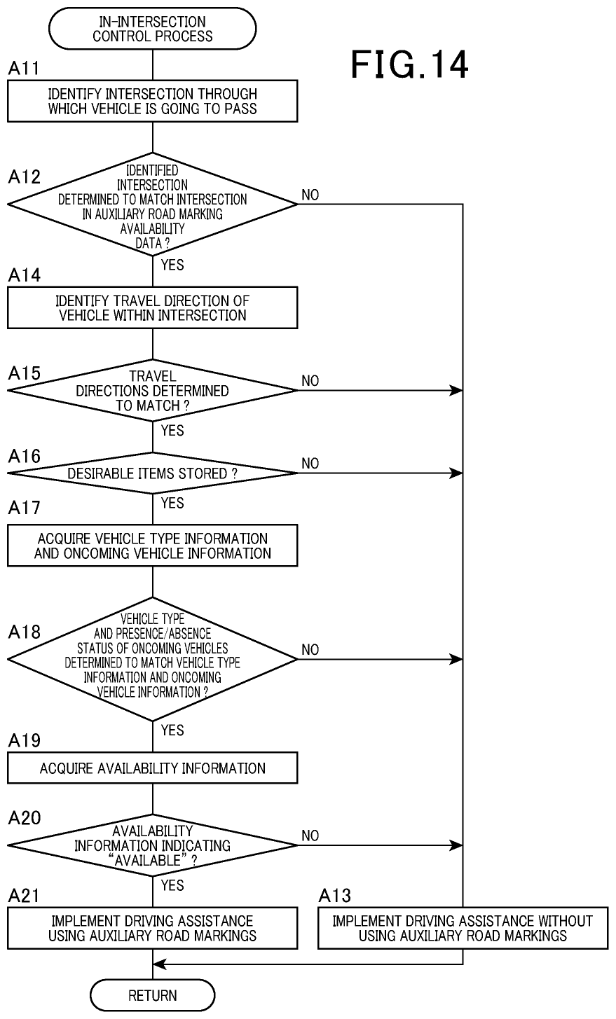

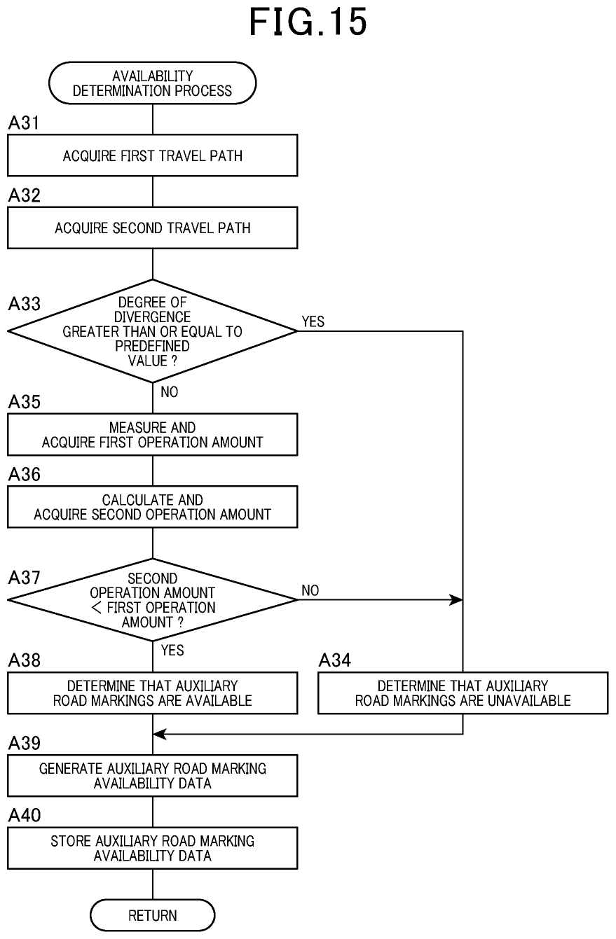

The operations in the above configuration will now be described with reference to FIGS. 13 through 22. Here, an auxiliary road marking availability data generation process and an auxiliary road marking availability data transmission process will be described as processes performed by the on-board device 2. In addition, a map data update process and a map data delivery process will now be described as processes performed by the server 3. In the following, it is assumed that the vehicle is of “vehicle type A” and the vehicle is traveling by autonomous driving.

(1) Auxiliary Road Marking Availability Data Generation Process (See FIGS. 13 to 18)

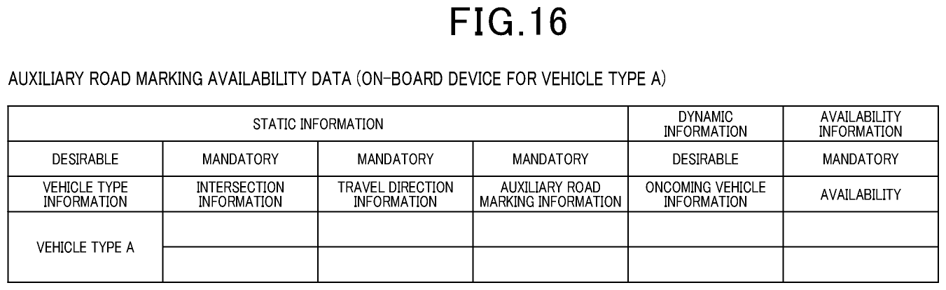

In the on-board device 2, when an initiation event for the auxiliary road marking availability data generation process is established by, for example, switching on of the ignition, the control unit 5 initiates the auxiliary road marking availability data generation process and sets static and dynamic information items for the auxiliary road marking availability data (at step A1). The control unit 5 sets vehicle type information, intersection information, travel direction information, and auxiliary road marking information as the static information items, and sets oncoming vehicle information as the dynamic information items. In this case, as illustrated in FIG. 16, in the initial state, the vehicle type (vehicle type A) is stored in the vehicle type information field, but no values are stored in the intersection information, travel direction information, and auxiliary road marking information fields. The control unit 5 initiates vehicle control (at step A2) and determines whether the vehicle is going to pass through an intersection based on the location and direction of travel of the vehicle and the location of the intersection (at step A3). If the control unit 5 determines that the vehicle is going to pass through an intersection (the YES branch of step A3), the process flow proceeds to an in-intersection control process (at step A4).

Upon initiating the in-intersection control process, the control unit 5 refers to map data stored in the map data storage unit 8 and identifies the intersection through which the vehicle is going to pass (at step A11). Upon identifying the intersection through which the vehicle is going to pass, the control unit 5 determines whether the identified intersection matches an intersection in auxiliary road marking availability data reflected in the map data, and determines the presence or absence of the auxiliary road marking availability data for the intersection through which the vehicle is going to pass (at step A12). If the control unit 5 determines that the identified intersection does not match any intersection in auxiliary road marking availability data reflected in the map data and that there is no auxiliary road marking availability data for the intersection through which the vehicle is going to pass (the NO branch of step A12), the control unit 5 implements driving assistance without using auxiliary road markings (at step A13). That is, the control unit 5 generates a first travel path that use no auxiliary road markings within the intersection and outputs to the driving control system 10 a control signal that instructs implementation of driving assistance without using auxiliary road markings. The driving control system 10 then controls the vehicle to travel along the first travel path within the intersection. After completing driving assistance without using auxiliary road markings and terminating the in-intersection control process, the control unit 5 returns to the auxiliary road marking availability data generation process and determines whether auxiliary road markings have been used in the vehicle control (at step A5).

If the control unit 5 determines that the identified intersection matches an intersection in auxiliary road marking availability data reflected in the map data and that the auxiliary road marking availability data is present for the intersection that the vehicle is going to pass through (the YES branch of step A12), the control unit 5 identifies the travel direction of the vehicle within the intersection (at step A14) and determines whether the identified travel direction matches the travel direction indicated by the travel direction information stored in the auxiliary road marking availability data (at step A15). If the control unit 5 determines that the identified travel direction does not match the travel direction indicated by the travel direction information stored in the auxiliary road marking availability data (the NO branch of step A15), the control unit 5 implements driving assistance without using auxiliary road markings (at step A13). Upon completion of the in-intersection control process, the control unit 5 returns to the auxiliary road marking availability data generation process to determine whether auxiliary road markings have been used in the vehicle control (at step A5).

If the control unit 5 determines that the identified travel direction matches the travel direction indicated by the travel direction information stored in the auxiliary road marking availability data (the YES branch of step A15), the control unit 5 determines whether DESIRABLE items are stored in the auxiliary road marking availability data (at step A16). If the control unit 5 determines that no DESIRABLE items are stored in the auxiliary road marking availability data (the NO branch of step A16), the control unit 5 implements driving assistance without using auxiliary road markings (at step A13). Upon completion of the in-intersection control process, the control unit 5 returns to the auxiliary road marking availability data generation process to determine whether auxiliary road markings have been used in the vehicle control (at step A5).

If the control unit 5 determines that DESIRABLE items are stored in the auxiliary road marking availability data (the YES branch of step A16), the control unit 5 acquires the vehicle type information and the oncoming vehicle information as the DESIRABLE items (at step A17), and then determines whether the vehicle type information and the oncoming vehicle information thus acquired match the vehicle type and the presence/absence status of oncoming vehicles (at step A18). If the control unit 5 determines that the vehicle type does not match the vehicle type information in the auxiliary road marking availability data or that the presence/absence status of oncoming vehicles does not match the oncoming vehicle information in the auxiliary road marking availability data (the NO branch of step A18), the control unit 5 implements driving assistance without using auxiliary road markings (at step A13). Upon completion of the in-intersection control process, the control unit 5 returns to the auxiliary road marking availability data generation process and determines whether auxiliary road markings have been used in the vehicle control (at step A5).

If the control unit 5 determines that the vehicle type of the vehicle matches the vehicle type information in the auxiliary road marking availability data and that the presence/absence status of oncoming vehicles matches the oncoming vehicle information in the auxiliary road marking availability data (the YES branch of step A18), the control unit 5 acquires the availability information (at step A19). The control unit 5 determines whether the acquired availability information indicates (at step A20). If the control unit 5 determines that the acquired availability information indicates “UNAVAILABLE” (the NO branch of step A20), then the control unit 5 implements driving assistance without using auxiliary road markings (at step A13). Upon completion of the in-intersection control process, the control unit 5 returns to the auxiliary road marking availability data generation process to determine whether auxiliary road markings have been used in the vehicle control (at step A5).

If the control unit 5 determines that the availability information indicates “AVAILABLE” (the YES branch of step A20), the control unit 5 implements driving assistance using auxiliary road markings reflected in the map data (at step A21). That is, the control unit 5 generates a second travel path using auxiliary road markings within the intersection and outputs to the driving control system 10 a control signal that instructs implementation of driving assistance using the auxiliary road markings. In this case, the driving control system 10 controls the vehicle to travel along the second travel path within the intersection. After completing the vehicle control within the intersection and terminating the in-intersection control process, the control unit 5 returns to the auxiliary road marking availability data generation process and determines whether auxiliary road markings have been used in the vehicle control (step A5).

Upon implementing driving assistance without using auxiliary road markings and determining that auxiliary road markings have not been used in the vehicle control (the NO branch of step A5), the control unit 5 proceeds to the availability determination process (at step A6). Upon initiating the availability determination process, the control unit 5 acquires a first travel path for which vehicle control has actually been performed (at step A31) and acquires a second travel path for which vehicle control has not actually been performed (at step A32). The control unit 5 determines the degree of divergence between the first travel path and the second travel path (at step A33). If it is determined that the degree of divergence is greater than or equal to a predefined value and the second travel path is extremely bulging outward or extremely constricted inward relative to the first travel path (the YES branch of step A33), the control unit 5 determines that auxiliary road markings are unavailable (at step A34). That is, if the control unit 5 determines that the degree of divergence between the first travel path for which vehicle control has actually been performed without using auxiliary road markings and the second travel path calculated using the auxiliary markings is greater than or equal to a predefined value, the control unit 5 determines that auxiliary road markings are unavailable. Upon completion of the availability determination process, the control unit 5 returns to the auxiliary road marking availability data generation process.

If the control unit 5 determines that the degree of divergence is less than the predefined value and that the second travel path is neither extremely bulging outward nor extremely constricted inward relative to the first travel path (the NO branch of step A33), the control unit 5 measures and acquires the first operation amount for the driving operation when the vehicle has actually passed through the intersection according to the first travel path (at step A35), and calculates and acquires a second operation amount for the driving operation when the vehicle is assumed to pass through the intersection according to the second driving path (at step A36).

The control unit 5 compares the first operation amount and the second operation amount (at step A37). If the control unit 5 determines that the second operation amount is not less than the first operation amount (the NO branch of step A37), the control unit 5 determines that auxiliary road markings are unavailable (at step A34).

If the control unit 5 determines that the second operation amount is less than the first operation amount (the YES branch of step A37), the control unit 5 determines that the auxiliary road markings are available (at step A38). That is, if the control unit 5 determines that the degree of divergence between the first travel path for which vehicle control has actually been performed without using auxiliary road markings and the second travel path for which vehicle control has not actually been performed is less than the predefined value and that the steering operation according to the second travel path is smoother than the steering operation according to the first travel path, the control unit 5 determines that the auxiliary road markings are available. Upon completion of the availability determination process, the control unit 5 returns to the auxiliary road marking availability data generation process.

Upon determining the availability of auxiliary road markings, the control unit 5 generates auxiliary road marking availability data by associating the availability information, static information, and dynamic information with each other, and storing values in the intersection information, travel direction information, auxiliary road marking information, and oncoming vehicle information fields (at step A39). The control unit 5 stores the generated auxiliary road marking availability data in the auxiliary road marking availability data storage unit 9 (at step A40), terminates the availability determination process, and returns to the auxiliary road marking availability data generation process.

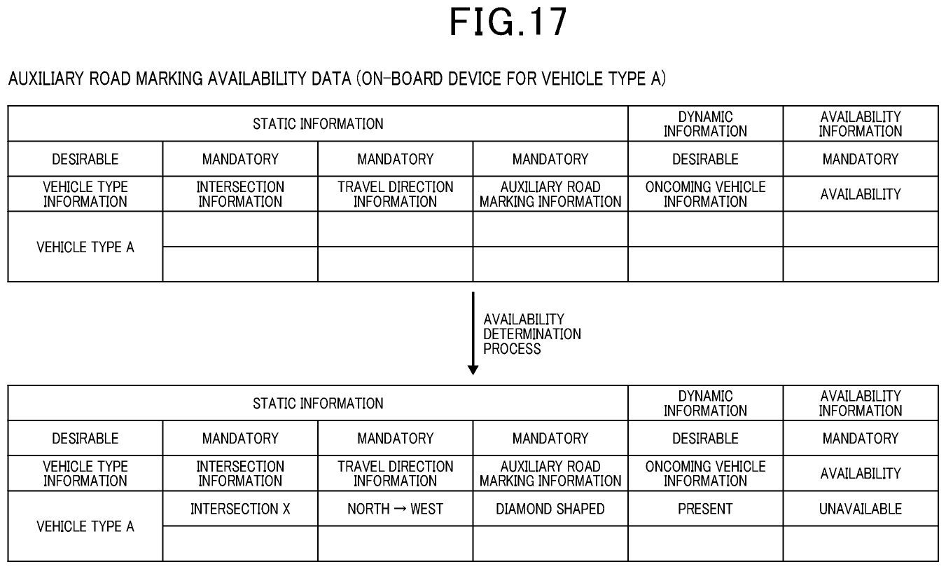

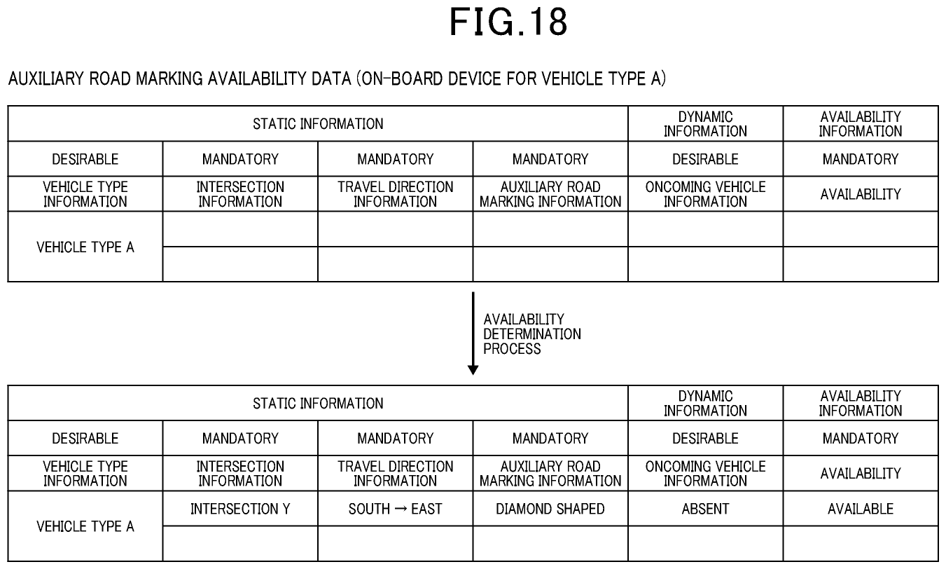

That is, in a case where a vehicle of vehicle type A enters an intersection X with a diamond shaped marking painted on the road surface from the north direction, turns right within the intersection, and exits the intersection to the west direction in the presence of an oncoming vehicle, the control unit 5 determines that auxiliary road markings are unavailable. In such a case, one finds that, as illustrated in FIG. 17, “INTERSECTION X” is stored in the intersection information field, “NORTH-->WEST” in the travel direction information field, “DIAMOND SHAPED” in the auxiliary road marking information field, and “PRESENT” in the oncoming vehicle information field, “UNAVAILABLE” in the availability information field. In another case where a vehicle of vehicle type A enters an intersection Y with a diamond shaped marking painted on the road surface from the south direction, turns right within the intersection, and exits the intersection to the east direction in the absence of an oncoming vehicle, the control unit 5 determines that auxiliary road markings are available. In such a case, one finds that, as illustrated in FIG. 18, “INTERSECTION Y” is stored in the intersection information field, “SOUTH-->EAST” in the travel direction information field, “DIAMOND SHAPED” in the auxiliary road marking information field, “ABSENT” in the oncoming vehicle information field, and “AVAILABLE” in the availability information field.

Returning to the auxiliary road marking availability data generation process, the control unit 5 determines whether a termination condition for vehicle control is met (at step A7). If the control unit 5 determines that the termination condition for vehicle control is not met (the NO branch of step A7), the control unit 5 returns to step A3 and repeats step A3 and subsequent steps. That is, the control unit 5 performs the in-intersection control process each time the vehicle passes through an intersection, and in response to determining that auxiliary road markings have not been used in the vehicle control of the in-intersection control process, the control unit 5 performs the availability determination process. If the control unit 5 determines that the termination condition for vehicle control is met (the YES branch of step A7), the control unit 5 terminates the vehicle control (at step A8) and terminates the auxiliary road marking availability data generation process.

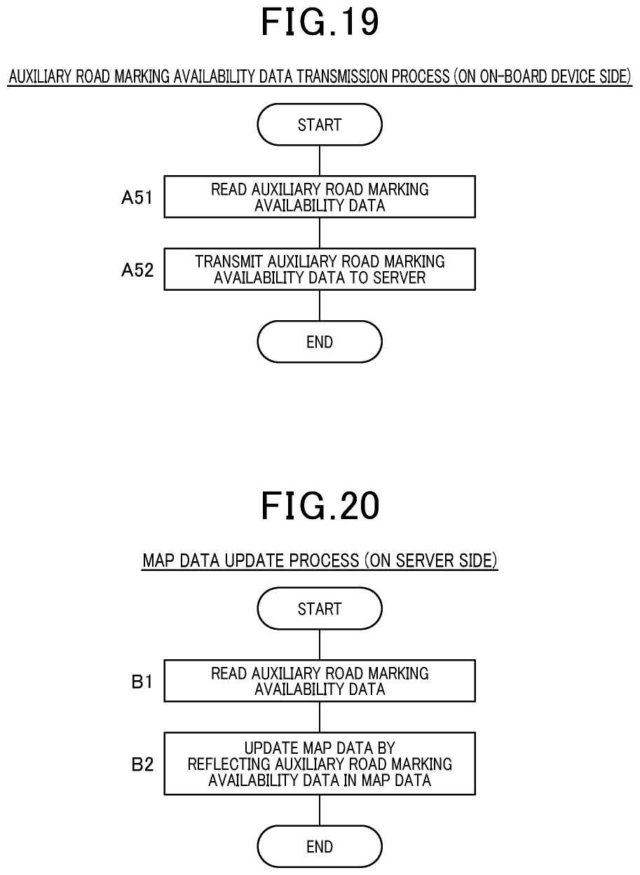

(2) Auxiliary Road Marking Availability Data Transmission Process (See FIG. 19)

In the on-board device 2, when the transmission condition for the auxiliary road marking availability data is met and the initiation event for the auxiliary road marking availability data transmission process is established, the control unit 5 reads the auxiliary road marking availability data stored in the auxiliary road marking availability data storage unit 9 (at step A51). The control unit 5 transmits the read auxiliary road marking availability data from the data communication unit 6 to the server 3 (at step A52), terminates the auxiliary road marking availability data transmission process, and waits for the next time the transmission condition for auxiliary road marking availability data is met.

(3) Map Data Update Process (See FIG. 20)

In the server 3, when the map data update condition is met and the initiation event for the map data update process is established, the control unit 12 reads the auxiliary road marking availability data stored in the auxiliary road marking availability data storage unit 16 (at step B1). The control unit 12 updates the map data by reflecting the read auxiliary road marking availability data in the map data stored in the map data storage unit 15 (at step B2), terminates the map data update process, and waits for the next time the map data update condition is met.

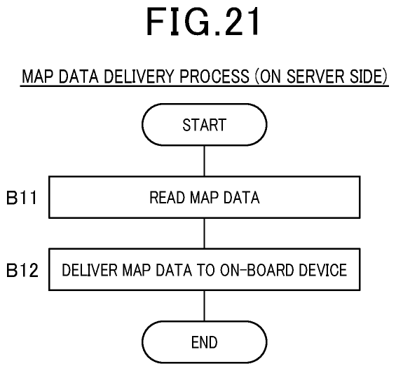

(4) Map Data Delivery Process (See FIG. 21)

In the server 3, when the map data delivery condition is met and the initiation event for the map data delivery process is established, the control unit 12 reads the map data stored in the map data storage unit 15 (at step B11). The control unit 12 delivers the read map data from the data communication unit 13 to the on-board device 2 (at step B12), terminates the map data delivery process, and waits for the next time the map data delivery condition is met.

In the above embodiment, it has been assumed that a vehicle is traveling by autonomous driving. In the autonomous driving system 10, driving of the vehicle is controlled such that the vehicle passes through an intersection according to a first or second travel path. In an alternative embodiment, it may be assumed that a vehicle is traveling in manual diving. The notification system 11 may notify the driver of a stop position within an intersection according to a first or second travel path, an initiation timing of steering, a termination timing of steering, and so on.

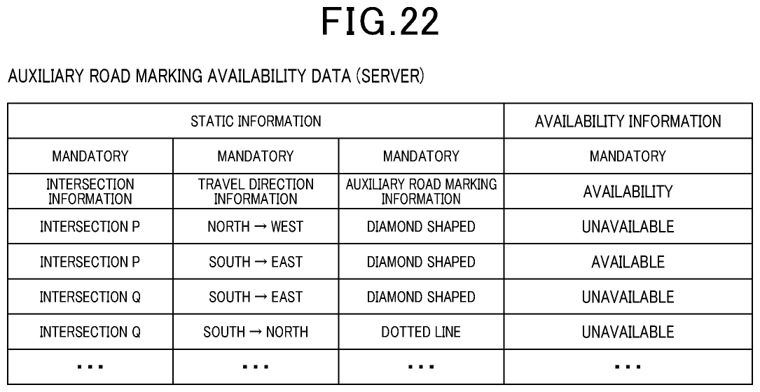

In the above embodiment, the DESIRABLE and MANDATORY items are included in the auxiliary road marking availability data. In an alternative embodiment, as illustrated in FIG. 22, the DESIRABLE items may be omitted from the auxiliary road marking availability data. That is, at an intersection where a suitable travel path for a vehicle to make a right turn in the intersection is affected by the size of the vehicle and the presence or absence of oncoming vehicles, auxiliary road marking availability data including vehicle type and oncoming vehicle information may be generated as illustrated in FIG. 12. In addition, at an intersection where a suitable travel path for a vehicle to make a right turn in the intersection is not affected by the size of the vehicle and the presence or absence of oncoming vehicles, as illustrated in FIG. 22, auxiliary road marking availability data may be generated that does not include vehicle type and oncoming vehicle information. Auxiliary road marking availability data may be generated that includes either of the vehicle type information and oncoming vehicle information, instead of auxiliary road marking availability data that includes both of the vehicle type information and oncoming vehicle information.

According to the present embodiment as described above, the following effects can be achieved.

The on-board device 2 acquires availability information indicating availability of auxiliary road markings within an intersection, determines the availability of the auxiliary road markings within the intersection, and determines whether to implement driving assistance using the auxiliary road markings based on a determination result of the availability of the auxiliary road markings within the intersection. When it is determined that the auxiliary road markings within the intersection are unavailable, driving assistance is not implemented using the auxiliary road markings. When it is determined that the auxiliary road markings within the intersection are available, driving assistance is implemented using the auxiliary road markings. This allows for implementation of driving assistance using auxiliary road markings within an intersection only in a situation where it is appropriate to use the auxiliary markings within the intersection, and thus allows for proper use of the auxiliary road markings within the intersection.

The on-board device 2 is configured to determine vehicle type information regarding the vehicle type and determine availability of auxiliary road markings within an intersection. Determining the availability of auxiliary road markings within the intersection taking into account the vehicle type information can solve the issue that, for example, a travel path suitable for a standard-sized vehicle to turn right within an intersection differs from a travel path suitable for a large-sized vehicle to turn right within the same intersection, which allows for proper use of the auxiliary road markings within the intersection according to the vehicle type.

The on-board device 2 is configured to determine oncoming vehicle information regarding the presence or absence of oncoming vehicles and determine availability of auxiliary road markings within an intersection. Determining the availability of auxiliary road markings within the intersection taking into account the presence or absence of oncoming vehicles can solve the issue that a travel path suitable for turning right within the intersection in a situation where there are no oncoming vehicles and a travel path suitable for turning right within the intersection in a situation where there are oncoming vehicles may be different, which allows for proper use of the auxiliary road markings within the intersection according to the presence or absence of oncoming vehicles.

The on-board device 2 is configured to generate auxiliary road marking availability data including availability information indicating availability of auxiliary markings within an intersection and transmit the generated auxiliary road marking availability data to the server 3. This allows the server 3 to manage the availability of auxiliary road markings within the intersection, allowing for proper use of auxiliary road markings within the intersection.

The on-board device 2 is configured to generate auxiliary road marking availability data by associating the availability information with the vehicle type information regarding the vehicle type and transmit the generated auxiliary road marking availability data to the server 3. This allows the server 3 to manage the availability of auxiliary road markings within the intersection according to the vehicle type.

The on-board device 2 is configured to generate auxiliary road marking availability data by associating the availability information with the oncoming vehicle information regarding the presence or absence of oncoming vehicles and transmit the generated auxiliary road marking availability data to the server 3. This allows the server 3 to manage the availability of auxiliary road markings within the intersection according to the presence or absence of oncoming vehicles.

The server 3 is configured to, upon receiving the auxiliary road marking availability data from the on-board device 2, update map data by reflecting the auxiliary road marking availability data in the map data. This allows for generation of map data that reflects the availability of auxiliary road markings within the intersection, thereby allowing for proper use of auxiliary road markings within the intersection.

Although the present disclosure has been described in accordance with the above described embodiments, it is not limited to such embodiments or configurations, but also encompasses various variations and variations within equal scope. In addition, various combinations and forms, as well as other combinations and forms, including only one element, more or less, thereof, are also within the scope and idea of the present disclosure.

The above embodiment is directed to countries and regions where Road Traffic Laws stipulate left-hand traffic. The above embodiment may be modified to cover countries and regions where Road Traffic Laws stipulate right-hand traffic. Such a modification may be applied to a situation where a vehicle turns left within an intersection.

Although information regarding the presence or absence of oncoming vehicles has been described as an example of oncoming vehicle information, information regarding types of oncoming vehicles may also be added. That is, assuming that a suitable travel path for a vehicle to make a right turn within an intersection may be affected by the size of an oncoming vehicle, it may be determined whether auxiliary road markings are available, according to the type of the vehicle waiting in the lead among the oncoming vehicles in the intersection. For example, if the vehicle waiting in the lead among the oncoming vehicles in the intersection is of a vehicle type A, auxiliary road markings may be determined to be available, whereas if the vehicle waiting in the lead among the oncoming vehicles in the intersection is of a vehicle type B, auxiliary road markings may be determined to be unavailable.

The control units and their methods described in relation to the present disclosure may be implemented by a dedicated computer that is provided by forming a processor and a memory programmed to execute one or more functions embodied by a computer program. Otherwise, the control units and their methods described in relation to the present disclosure may be implemented by a dedicated computer that is provided by forming a processor from one or more dedicated hardware logic circuits. Alternatively, the control units and their methods described in relation to the present disclosure may be implemented by one or more dedicated computers that are formed by a combination of a processor and a memory programmed to execute one or more functions and one or more hardware logic circuits. The computer program may be stored as instructions to be executed by a computer in a computer-readable non-transitory tangible recording medium.

What is claimed is:

1. An on-board device for a vehicle, comprising:
a map data storage unit configured to store map data including availability information that indicates availability of an auxiliary road marking within an intersection;
an availability information acquisition unit configured to acquire the availability information;
an availability determination unit configured to determine the availability of the auxiliary road marking within the intersection, indicated by the availability information; and
a driving assistance implementation unit configured to determine whether to implement driving assistance using the auxiliary road marking based on a result of determination of the availability of the auxiliary road marking within the intersection.

2. The on-board device according to claim 1, wherein
the map data includes vehicle type information regarding a type of the vehicle, associated with the availability information,
the availability information acquisition unit is configured to acquire the availability information and the vehicle type information, and
the utilization availability determination unit is configured to determine the vehicle type information and to determine the availability of the auxiliary road marking within the intersection, indicated by the availability information.

3. The on-board device according to claim 1, wherein
the map data includes oncoming vehicle information regarding presence or absence of an oncoming vehicle, the oncoming vehicle information being associated with the availability information,
the availability information acquisition unit is configured to acquire the availability information and the oncoming vehicle information, and
the utilization availability determination unit is configured to determine the oncoming vehicle information and to determine the availability of the auxiliary road marking within the intersection, indicated by the availability information.

4. An on-board device for a vehicle, comprising:
an auxiliary road marking availability data generation unit configured to generate auxiliary road marking availability data that includes availability information indicating availability of an auxiliary road marking within an intersection, and
a transmission control unit configured to transmit the auxiliary road marking availability data to a server.

5. The on-board device according to claim 4, wherein
the auxiliary road marking availability data generation unit is configured to associate the availability information with vehicle type information regarding a type of the vehicle and generate auxiliary road marking availability data that includes the availability information and the vehicle type information.

6. The on-board device according to claim 4, wherein
the auxiliary road marking availability data generation unit is configured to associate the availability information with oncoming vehicle information regarding presence or absence of an oncoming vehicle and generate auxiliary road marking availability data that includes the availability information and the oncoming vehicle information.

7. The on-board device according to claim 4, further comprising:
a first travel path generation unit configured to generate a first travel path that is a travel path for implementing driving assistance without using the auxiliary road marking within the intersection;
a second travel path generation unit configured to generate a second travel path that is a travel path for implementing driving assistance using the auxiliary road marking within the intersection;
a first operation amount acquisition unit configured to acquire a first operation amount for a driving operation when the vehicle passes through the intersection according to the first travel path; and
a second operation amount acquisition unit configured to acquire a second operation amount for a driving operation when the vehicle passes through the intersection according to the second travel path, wherein
the auxiliary road marking availability data generation unit is configured to generate auxiliary road marking availability data including the availability information based on a comparison between the first operation amount and the second operation amount.

8. A server communicable with an on-board device for a vehicle, comprising:
a map data storage unit configured to store map data;
a reception control unit configured to receive auxiliary road marking availability data from the on-board device, the auxiliary road marking availability data including availability information that includes availability of an auxiliary road marking within an intersection; and
a map data update unit configured to update the map data by reflecting the availability information in the map data.

9. The server according to claim 8, wherein
the reception control unit is configured to receive from the on-board device the auxiliary road marking availability data associated with the availability information and with vehicle type information regarding a type of the vehicle.

10. The server according to claim 8, wherein
the reception control unit is configured to receive from the on-board device the auxiliary road marking availability data associated with the availability information and with oncoming vehicle information regarding presence or absence of an oncoming vehicle.

11. The server according to claim 8, further comprising:
a delivery control unit configured to transmit to the on-board device the map data updated by the map data update unit.

12. A non-transitory computer-readable medium, having stored thereon a driving assistance program comprising instructions configured to cause a control unit of an on-board device for a vehicle, the on-board device being equipped with a map data storage unit configured to store map data including availability information that indicates availability of an auxiliary road marking within an intersection, to:
acquire the availability information;
determine the availability of the auxiliary road marking within the intersection, indicated by the availability information; and
determine whether to implement driving assistance using the auxiliary road marking based on a result of determination of the availability of the auxiliary road marking within the intersection.

13. A non-transitory computer-readable medium, having stored thereon an auxiliary road marking availability data transmission program comprising instructions configured to cause a control unit of an on-board device for a vehicle to:
generate auxiliary road marking availability data that includes availability information indicating availability of an auxiliary road marking within an intersection, and
transmit the auxiliary road marking availability data to a server.

14. A non-transitory computer-readable medium, having stored thereon a map data update program comprising instructions configured to cause a control unit of a server equipped with a map data storage unit configured to store map data to:
update the map data by reflecting, in the map data, auxiliary road marking availability data including availability information that indicates availability of an auxiliary road marking within an intersection.

15. A data structure of auxiliary road marking availability data for use in at least one of an on-board device for a vehicle and a server communicable with the on-board device, comprising:
availability information that indicates availability of an auxiliary road marking within an intersection,
vehicle type information regarding a type of the vehicle; and
oncoming vehicle information regarding presence or absence of an oncoming vehicle.

16. A computer-implemented method for controlling driving of a vehicle, comprising:
acquiring availability information that indicates availability of an auxiliary road marking within an intersection;
selecting one of a travel path using the auxiliary road marking, set according to the availability information, and a travel path set independently of the auxiliary road marking; and
causing the vehicle to pass through the intersection along the selected travel path.
